(19) United States
(12) Patent Application Publication
(10) Pub. No.: US 2017/0300268 A1
(43) Pub. Date: Oct. 19, 2017

(54) COMMUNICATION DEVICE, INFORMATION PROCESSING METHOD, AND RECORDING MEDIUM WITH INFORMATION PROCESSING PROGRAM

(71) Applicant: FUJITSU LIMITED, Kawasaki-shi (JP)

(72) Inventors: Hiroaki Kameyama, Kawasaki (JP); Shinichi Sazawa, Atsugi (JP); Masayoshi Hashima, Kawasaki (JP)

(73) Assignee: FUJITSU LIMITED, Kawasaki-shi (JP)

(21) Appl. No.: 15/641,868

(22) Filed: Jul. 5, 2017

Related U.S. Application Data
(63) Continuation of application No. PCT/JP2015/054573, filed on Feb. 19, 2015.

(51) Int. Cl. G06F 3/06

(52) U.S. Cl. CPC G06F 3/0647; G06F 3/067; G06F 3/0613; G06F 3/0641

(57) ABSTRACT

A communication device performs data transfer from a first device holding a data group to a second device that stores received data as a record of transfer. The communication device includes a storage that stores transmitted data as a record of transfer, and a processor configured to acquire, from the first device, data matching a predetermined condition among the data group, stores first data that is not retained in the storage, among the acquired data, in the storage, transmit the first data to the second device, and transmit, to the second device, when transfer of the first data from the first device to the second device is started in response to an acquisition request for the first data, identification information of the first data having a smaller size than the first data.

### CROSS-REFERENCE TO RELATED APPLICATION

This application is a continuation application of International Application PCT/JP2015/054573, filed on Feb. 19, 2015, and designated the U.S., the entire contents of which are incorporated herein by reference.

### FIELD

The present invention relates to a communication device, an information processing method, and a recording medium with an information processing program.

### BACKGROUND

As one method for increasing the speed of data transfer to a client terminal, there is data deduplication. In data deduplication, the transmitter-side and receiver-side devices each save, in a cache, data the device has transferred once, and keep a record of transfer. When the same data is to be transferred next, the transmitter-side device transfers ID data of the data, having a smaller size, instead of the data, and the receiver-side device reads the original data from the cache based on the ID data. For example, the ID data of data is information about the storage location in the cache, and the size is about 10 bytes to 100 bytes. The amount of data transfer between the transmitter-side device and the receiver-side device may thus be reduced, and the transfer time may be reduced.

### PATENT DOCUMENT

[Patent document 1] Japanese Patent Laid-Open No. 2009-205201

However, data deduplication has a problem that deduplication is not performed for data with no record of transfer because such data is not in the cache(s) of the transmitter side and/or the receiver side. For example, immediately after activation of a transfer device, there is no record of transfer and there is no data in the cache, and the transfer device is not able to perform deduplication of any data. Additionally, a record of transfer refers to a record that transfer was performed, and that there is no record of transfer means that there is no record that transfer was performed.

### SUMMARY

A mode of the present invention is a communication device that performs data transfer from a first device holding a data group to a second device that stores received data as a record of transfer. The communication device includes a storage configured to store transmitted data as a record of transfer, and a processor configured to acquire data matching a predetermined condition among the data group from the first device, store first data that is not retained in the storage among the acquired data in the storage, transmit the first data to the second device, and transmit, when transfer of the first data from the first device to the second device is started in response to an acquisition request for the first data, identification information of the first data having a smaller size than the first data to the second device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a configuration of a communication system according to a first embodiment, and an example of a process performed by the communication system;

FIG. 2 is a diagram illustrating an example of a hardware configuration of a transmitter-side transfer device;

FIG. 3 is a diagram illustrating an example of functional configurations of the transmitter-side transfer device and a receiver-side transfer device;

FIG. 4A is an example of a flowchart of a process by the transmitter-side transfer device;

FIG. 4B is an example of a flowchart of a process by the transmitter-side transfer device;

FIG. 5 is a diagram illustrating an example of a sequence of a process by the communication system for a case where a file attribute reference request is transmitted from a reception terminal.

### DESCRIPTION OF EMBODIMENT

Hereinafter, an embodiment of the present invention will be described with reference to the drawings. The configuration of the embodiment below is merely an example, and the present invention is not limited to the configuration of the embodiment.

### First Embodiment

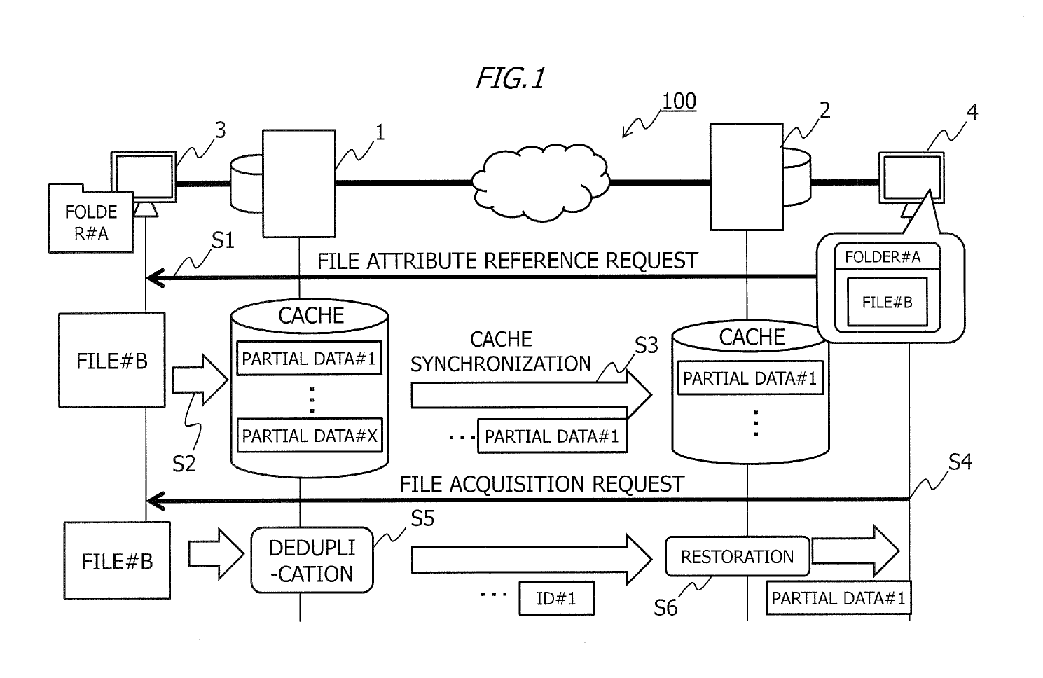

FIG. 1 is a diagram illustrating an example of a configuration of a communication system 100 according to a first embodiment, and an example of a process performed by the communication system 100. The communication system 100 includes, as transmitter-side devices, a transmitter-side transfer device 1 and a transmission terminal 3, and includes, as receiver-side devices, a receiver-side transfer device 2 and a reception terminal 4. The transmitter-side transfer device 1 and the receiver-side transfer device 2 are transfer devices for forwarding communication between the transmission terminal 3 and the reception terminal 4.

For example, the communication system 100 is a private network system inside a company, and the transmitter side is the network of the head office and the receiver side is the network of a branch office. For example, the transmitter-side transfer device 1 and the receiver-side transfer device 2 are connected to a carrier network, and the two are connected by a dedicated line or a virtual private network (VPN). The transmitter-side transfer device 1 and the transmission terminal 3, and the receiver-side transfer device 2 and the reception terminal 4 are connected by a local area network (LAN), for example.

The first embodiment assumes a case where the transmission terminal 3 and the reception terminal 4 execute a common internet file system (CIFS), which is a file sharing application, and where the reception terminal 4 accesses a folder #A in the transmission terminal 3. A file #B is assumed to be contained in the folder #A. The file #B is saved in the cache of neither the transmitter-side transfer device 1 nor the receiver-side transfer device 2.

In S1, in response to input of a selection operation for the folder #A by a user, the reception terminal 4 transmits, to the transmission terminal 3, a reference request for file attribute information (a file attribute reference request) regarding a file in the folder #A. A selection operation for the folder #A by a user is an operation of moving a mouse pointer over an icon of the folder #A displayed on a display and double-clicking a mouse button, for example. Information about a list of files held by the transmission terminal 3 is acquired by the reception terminal 4 by a CIFS process prior to the process in S1. Accordingly, it is grasped by the reception terminal 4 that the file #B is in the folder #A, and the file attribute reference request contains identification information of the target file #B in the folder #A. The file attribute reference request is an example of a “reference request”.

In response to the file attribute reference request from the reception terminal 4, the transmission terminal 3 transmits, to the reception terminal 4, file attribute information of the file #B in the folder #A. The file attribute information contains type information indicating a file or a folder, the name of the file or the folder, the belonging folder name of the file or the folder, the file size, and the like, for example. The file attribute information is an example of “attribute information”.

When the reception terminal 4 acquires the file attribute information of the file #B in the folder #A, an icon of the file #B is displayed on the display of the reception terminal 4, in the window of the folder #A, for example.

In S2, the transmitter-side transfer device 1 acquires information about the file #B at the time of transfer of the file attribute reference request transmitted from the reception terminal 4, transmits an acquisition request for the file #B to the transmission terminal 3, and acquires the file #B.

In S3, because the file #B is not saved in the cache, the transmitter-side transfer device 1 stores the file #B in the cache. Also, the transmitter-side transfer device 1 assumes that data which is not saved in the cache of the transmitter-side transfer device 1 is not saved in the cache of the receiver-side transfer device 2, and transmits the file #B to the receiver-side transfer device 2.

Because the file #B is not saved in the cache of the receiver-side transfer device 2, either, the receiver-side transfer device 2 stores the file #B in the cache when the file #B is received. Accordingly, the cached contents regarding the file #B are synchronized between the transmitter-side transfer device 1 and the receiver-side transfer device 2. Additionally, the destination of transmission of the file #B from the transmitter-side transfer device 1 in S3 is the receiver-side transfer device 2, and thus, the transmission is terminated at the receiver-side transfer device 2.

Additionally, the file #B is divided into pieces of partial data of a predetermined size, and the pieces of partial data are, in the form of partial data, stored in the cache of the transmitter-side transfer device 1, and transmitted to the receiver-side transfer device 2 and stored in the cache of the receiver-side transfer device 2. The size of the partial data is 3 kilobytes to 10 kilobytes, for example, and is sufficiently smaller than the file size.

In S4, because a selection operation for the file #B in the folder #A displayed on the display is performed by the user of the reception terminal 4, the reception terminal 4 transmits a file acquisition request for the file #B to the transmission terminal 3. When the file acquisition request for the file #B is received, the transmission terminal 3 transmits the file #B. The file acquisition request is an example of an “acquisition request”.

In S5, the transmitter-side transfer device 1 performs a deduplication process at the time of performing a transfer process of the file #B from the transmission terminal 3 to the receiver-side transfer device 2. Specifically, the deduplication process is as follows. However, the following deduplication process is merely an example, and an applicable deduplication process is not limited to the following process.

The transmitter-side transfer device 1 divides the received file #B into pieces of partial data, compares the data pieces against pieces of partial data in the cache, and determines whether matching piece(s) of data is/are in the cache. Regarding partial data for which a matching piece of data is in the cache, the transmitter-side transfer device 1 transmits the ID data of the partial data instead of the partial data itself. Regarding partial data for which a matching piece of data is not in the cache, the transmitter-side transfer device 1 transmits the partial data itself.

The ID data of partial data is the storage location of the partial data in the cache, the position (offset) of the partial data from a communication start of communication between the transmitter-side transfer device 1 and the receiver-side transfer device 2, or the like. Also, the ID data of partial data may be a hash value that is obtained by performing hash calculation on the partial data. Moreover, in the case where the ID data of partial data is the value of a predetermined calculation result, such as a hash value, the ID data of the partial data is to be stored in the cache together with the partial data. It is sufficient if the ID data of partial data is non-duplicated information which is common between the transmitter-side transfer device 1 and the receiver-side transfer device 2. The size of the ID data of partial data is about 4 bytes to 100 bytes, and is sufficiently smaller than the size of the partial data.

In S5, all the pieces of partial data of the file #B are saved in the cache, and thus, the ID data is transmitted for each piece of partial data of the file #B instead of the partial data itself.

In S6, the receiver-side transfer device 2 receives the ID data of each piece of partial data of the file #B. The receiver-side transfer device 2 reads the partial data corresponding to the ID data from the cache, and restores the partial data. The receiver-side transfer device 2 acquires the file #B by combining the restored pieces of partial data, and transfers the file #B to the reception terminal 4.

Accordingly, in the first embodiment, even when there is a data acquisition request from the reception terminal 4 for data with no record of transfer to the reception terminal 4, the deduplication process may be performed, and the amount of data transfer may be reduced.

### Device Configuration

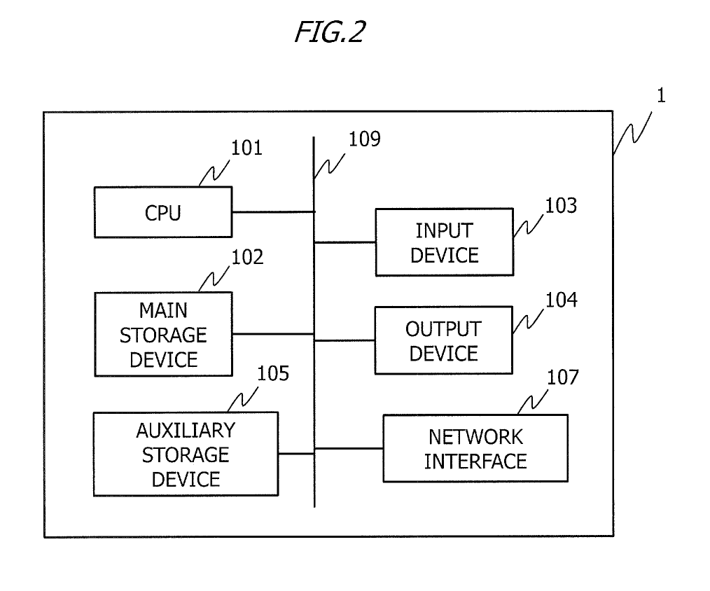

FIG. 2 is a diagram illustrating an example of a hardware configuration of the transmitter-side transfer device 1. For example, the transmitter-side transfer device 1 is a dedicated computer such as a server, or a general-purpose computer such as a personal computer (PC). The transmitter-side transfer device 1 is an example of a “communication device”.

The transmitter-side transfer device 1 includes a central processing unit (CPU) 101, a main storage device 102, an input device 103, an output device 104, an auxiliary storage device 105, and a network interface 107. Moreover, these are electrically interconnected by a bus 109.

The input device 103 is a touch panel, a keyboard, or a keypad, for example. Data input from the input device 103 is output to the CPU 101. The input device 103 may also include an audio input device such as a microphone, for example.

The auxiliary storage device 105 stores various programs, and data to be used by the CPU 101 at the time of execution of each program. The auxiliary storage device 105 is a non-volatile memory such as an erasable programmable ROM (EPROM), a flash memory, a hard disk drive, or the like, for example. The auxiliary storage device 105 holds the operating system (OS), a deduplication program, and various other application programs, for example. The deduplication program is a program for eliminating transmission of duplicate data by transmitting identification information instead of data at the time of duplicate transmission of data. The deduplication program is an example of an “information processing program”.

The main storage device 102 provides the CPU 101 with a storage area and a work area for loading programs which are retained in the auxiliary storage device 105, or is used as a buffer. The main storage device 102 includes a semiconductor memory such as a read only memory (ROM) or a random access memory (RAM), for example.

The CPU 101 performs various processes by loading, into the main storage device 102, and executing, the OS or various application programs held by the auxiliary storage device 105. A plurality of CPUs 101 may be provided instead of one.

The network interface 107 is an interface for input/output of information to/from a network. The network interface 107 includes an interface for connecting to a wired network, and an interface for connecting to a wireless network. For example, the network interface 107 is a network interface card (NIC), a wireless local area network (LAN) card, or a wireless circuit. Data and the like received by the network interface 107 are output to the CPU 101.

The output device 104 outputs the result of processing by the CPU 101. The output device 104 includes a display or a printer.

Additionally, the hardware configuration of the transmitter-side transfer device 1 illustrated in FIG. 2 is merely an example, and components may be omitted, substituted or added as appropriate according to the embodiment without being limited to the above example. For example, the transmitter-side transfer device 1 may include a removable recording medium drive device, and may execute a program recorded in a removable recording medium. The removable recording medium is a recording medium such as an SD card, a mini SD card, a micro SD card, a universal serial bus (USB) flash memory, a compact disc (CD), a digital versatile disc (DVD), a Blu-ray (registered trademark) disc, or a flash memory card, for example. Also, in the case where the transmitter-side transfer device 1 is a server, the transmitter-side transfer device does not have to be provided with the input device 103 and the output device 104.

The receiver-side transfer device 2 is a dedicated computer such as a server, or a general-purpose computer such as a PC, and has the same hardware configuration as the transmitter-side transfer device 1. The transmission terminal 3 and the reception terminal 4 are each a PC, a smartphone, or a tablet terminal, for example. The hardware configurations of the transmission terminal 3 and the reception terminal 4 are similar to the hardware configuration illustrated in FIG. 2, and are omitted from the drawings. The receiver-side transfer device 2 is an example of a “second device”.

The hardware configurations of the transmission terminal 3 and the reception terminal 4 each include a CPU, a main storage device, an auxiliary storage device, a touch panel and a microphone as input devices, a display or a speaker as an output device, and a wireless unit as a network interface for performing a wireless communication process. Moreover, the transmission terminal 3 and the reception terminal 4 may also include a removable recording medium drive device. The transmission terminal 3 is an example of a “first device”.

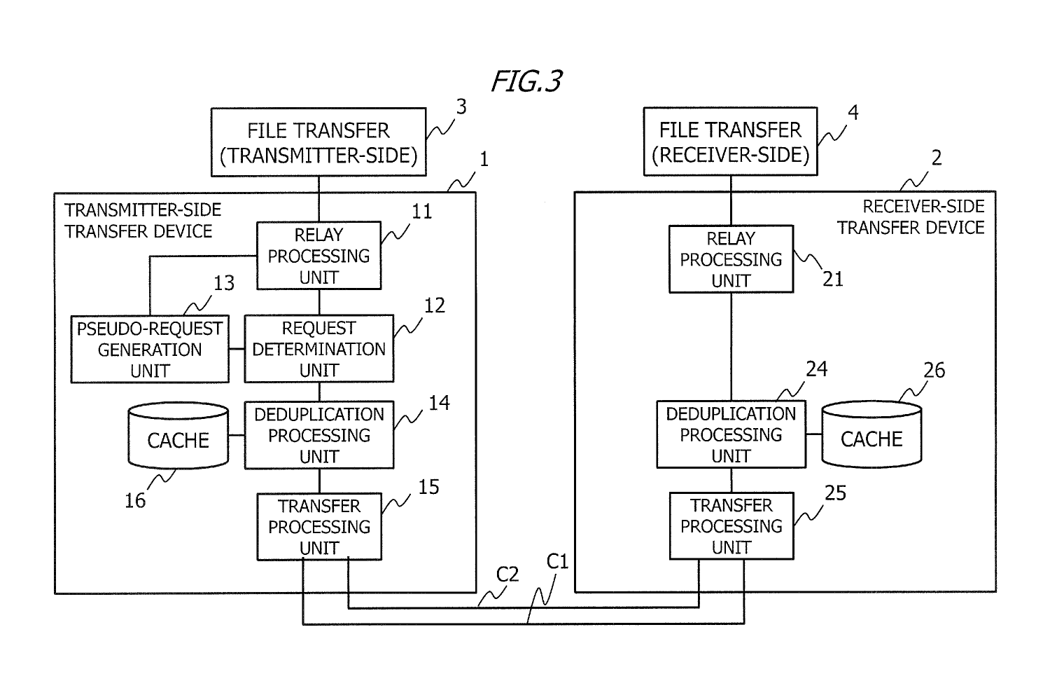

FIG. 3 is a diagram illustrating an example of functional configurations of the transmitter-side transfer device 1 and the receiver-side transfer device 2. The transmitter-side transfer device 1 includes a relay processing unit 11, a request determination unit 12, a pseudo-request generation unit 13, a deduplication processing unit 14, a transfer processing unit 15, and a cache 16. These functional configurations are functional configurations that are achieved by the CPU 101 executing a deduplication program stored in the auxiliary storage device 105. Also, when the deduplication program is executed, an area for the cache 16 is secured in the storage area in the auxiliary storage device 105.

In the transmitter-side transfer device 1, data to be transferred from the transmission terminal 3 to the receiver-side transfer device 2 passes through the functional configurations in the order of the relay processing unit 11, the request determination unit 12, the deduplication processing unit 14, and the transfer processing unit 15. Also, in the transmitter-side transfer device 1, data to be transferred from the receiver-side transfer device 2 to the transmission terminal 3 passes through the functional configurations in the order of the transfer processing unit 15, the deduplication processing unit 14, the request determination unit 12, and the relay processing unit 11.

The request determination unit 12 detects, from the data to be transferred by the transmitter-side transfer device 1, a file attribute reference request and file attribute information. In the first embodiment, the file attribute reference request and the file attribute information are CIFS messages, and thus, the request determination unit 12 detects the file attribute reference request and the file attribute information by determining the message type.

When the file attribute reference request is detected, the request determination unit 12 acquires identification information of a target file of the file attribute reference request. Next, the request determination unit 12 detects the file attribute information of the target file, and determines whether the size of the target file is below a threshold.

If the size of the target file is below the threshold, the request determination unit 12 instructs the pseudo-request generation unit 13 to transmit a pseudo file acquisition request for the target file. If the size of the target file is at or above the threshold, the request determination unit 12 cancels transmission of the target file to the receiver-side transfer device 2. This is because transmission of such a target file to the receiver-side transfer device 2 takes a long time, and may possibly affect communication through a session between the transmission terminal 3 and the reception terminal 4.

When the instruction is received from the request determination unit 12, the pseudo-request generation unit 13 generates a pseudo file acquisition request for the target file of the file attribute reference request, and transmits the pseudo file acquisition request to the transmission terminal 3. In the case where there are a plurality of target files for the file attribute reference request, the request determination unit 12 transmits a pseudo file acquisition request for the plurality of files. The pseudo file acquisition request is output to the relay processing unit 11, and is transmitted from the relay processing unit 11 to the transmission terminal 3.

The pseudo file acquisition request has the same format as the file acquisition request, or may be a file acquisition request of a different file transfer protocol, for example. A destination IP address of the file attribute reference request is used as a destination IP address of the pseudo file acquisition request. For example, a source IP address of the pseudo file acquisition request may be any of an IP address of the transmitter-side transfer device 1, an IP address of the reception terminal 4, which is a source IP address of the file attribute reference request, and an IP address of the receiver-side transfer device 2. The IP address of the receiver-side transfer device 2 is assumed to have been acquired in a negotiation performed between the transmitter-side transfer device 1 and the receiver-side transfer device 2 prior to the file attribute reference request from the reception terminal 4 to the transmission terminal 3.

In accordance with transmission of the pseudo file acquisition request, the pseudo-request generation unit 13 establishes a new session C2 between the transmitter-side transfer device 1 and the transmission terminal 3, and between the transmitter-side transfer device 1 and the receiver-side transfer device 2. The session C2 is a session for transferring a file which is the target of the pseudo file acquisition request so that the data of the file is saved in the caches of the transmitter-side transfer device 1 and the receiver-side transfer device 2 prior to the file acquisition request from the reception terminal 4. Hereinafter, the session C2 will be referred to as a look-ahead session C2. The look-ahead session is an example of a “first session”.

The look-ahead session C2 may be a CIFS session which is used for the session between the transmission terminal 3 and the reception terminal 4, or a session of a file transfer protocol different from the CIFS. Hereinafter, a CIFS session S1 between the transmission terminal 3 and the reception terminal 4 will be referred to as a file transfer session C1. The file transfer session is an example of a “second session”.

The file transfer session C1 between the reception terminal 4 and the transmission terminal 3 is different from the look-ahead session C2 between the transmitter-side transfer device 1 and the transmission terminal 3 and between the transmitter-side transfer device 1 and the receiver-side transfer device 2. At the transmitter-side transfer device 1 and the receiver-side transfer device 2, a session is identified by session identification information. The session identification information is one or a combination of the source and destination IP addresses, the source and destination port numbers, and a session identification number, for example. Accordingly, data which flows through the file transfer session C1 and data which flows through the look-ahead session C2 are identified by the transmitter-side transfer device 1 and the receiver-side transfer device 2 based on the session identification information.

The look-ahead session C2 may be different between a session between the transmitter-side transfer device 1 and the transmission terminal 3 and a session between the transmitter-side transfer device 1 and the receiver-side transfer device 2. That is, the session between the transmitter-side transfer device 1 and the transmission terminal 3 may be terminated at the relay processing unit 11, and the session between the transmitter-side transfer device 1 and the receiver-side transfer device 2 may be terminated at the transfer processing unit 15.

In this case, the source IP address of the pseudo file acquisition request is the IP address of the transmitter-side transfer device 1. Accordingly, at the time of the transmission terminal 3 transmitting a file in response to the pseudo file acquisition request, the IP address of the transmitter-side transfer device 1 is made the destination. Data of the session between the transmitter-side transfer device 1 and the transmission terminal 3 is transferred to the pseudo-request generation unit 13 by the relay processing unit 11, the pseudo-request generation unit 13 migrates the data to the session between the transmitter-side transfer device 1 and the receiver-side transfer device 2. Accordingly, the destination of the data of the file acquired from the transmission terminal 3 in response to the pseudo file acquisition request is made the IP address of the receiver-side transfer device 2 at the time of transmission of the data from the transmitter-side transfer device 1.

Moreover, the look-ahead session C2 may be one session between the transmission terminal 3 and the receiver-side transfer device 2 without the session between the transmitter-side transfer device 1 and the transmission terminal 3 and the session between the transmitter-side transfer device 1 and the receiver-side transfer device 2 being terminated at the transmitter-side transfer device 1. In this case, the source IP address of the pseudo file acquisition request is the IP address of the receiver-side transfer device 2 or the reception terminal 4. Also, in this case, migration between sessions, by the pseudo-request generation unit 13, of the data of the file acquired from the transmission terminal 3 is not performed. In the case where the source IP address of the pseudo file acquisition request is the IP address of the reception terminal 4, the destination of the data of the file acquired by the pseudo file acquisition request is the IP address of the reception terminal 4. Accordingly, the receiver-side transfer device 2 terminates the look-ahead session C2 without transferring, to the reception terminal 4, data flowing through the look-ahead session C2, even if the IP address of the reception terminal 4 is set as the destination IP address.

The deduplication processing unit 14 performs the following deduplication process on data which flows in the direction from the transmission terminal 3 to the receiver-side transfer device 2, that is, data which is input from the request determination unit 12. The relay processing unit 11 formats a packet input from the transmission terminal 3 into data of the size of an input buffer, and outputs the data in the direction of the request determination unit 12. The size of the input buffer of the relay processing unit 11 is 50 kilobytes to 100 kilobytes, for example.

The deduplication processing unit 14 divides the data input according to the size of the input buffer of the relay processing unit 11 into pieces of partial data of a predetermined size. The size of the partial data is 2 kilobytes to 8 kilobytes, for example. The size of the partial data may be fixed or variable. The deduplication processing unit 14 compares partial data obtained by division against partial data that is saved in the cache 16, and in the case where there is no piece of data matching the partial data obtained by division, the deduplication processing unit 14 stores the partial data in the cache 16, and outputs the same to the transfer processing unit 15. In the case where partial data matching the partial data obtained by division is present in the cache 16, the deduplication processing unit 14 outputs the ID data of the partial data to the transfer processing unit 15. The ID data may be the storage location of the partial data in the cache 16, or may be acquired from the partial data by predetermined hash calculation. The ID data is an example of “identification information of data”.

The relay processing unit 11 is an interface to the transmission terminal 3. The transfer processing unit 15 is an interface to the receiver-side transfer device 2. In the case of outputting data to outside, the relay processing unit 11 or the transfer processing unit 15 divides the data by the packet size, generates a packet by adding a header based on respective session identification information to each data piece of the packet size, and transmits the generated packet to the outside. The packet size is less than 1500 bytes, for example.

In the case of receiving a packet from outside, the relay processing unit 11 or the transfer processing unit 15 extracts a data piece of the packet size by removing the header from the packet, and stores the extracted data in the input buffer. When there are data pieces equal to the buffer size of the input buffer, or when a predetermined period of time has passed from input of data to the input buffer, the relay processing unit 11 or the transfer processing unit 15 outputs the data stored in the input buffer as one bulk of data to another internal functional configuration.

The cache 16 is created in a storage area of the auxiliary storage device 105. The cache 16 retains partial data, or partial data and ID data. For example, if partial data is not accessed for a predetermined period of time, the partial data may be deleted from the cache 16. The predetermined period of time is set to a relatively long unit of time such as 12 hours, one day, or one week, for example. The cache 16 is an example of a “storage”.

As the functional configurations, the receiver-side transfer device 2 includes a relay processing unit 21, a deduplication processing unit 24, a transfer processing unit 25, and a cache 26. These functional configurations are functional configurations that are achieved by a CPU of the receiver-side transfer device 2 executing a deduplication program stored in an auxiliary storage device. Also, when the deduplication program is executed, an area for the cache 26 is secured in the storage area in the auxiliary storage device of the receiver-side transfer device 2.

In the receiver-side transfer device 2, data to be transferred from the reception terminal 4 to the transmitter-side transfer device 1 passes through the functional configurations in the order of the relay processing unit 21, the deduplication processing unit 24, and the transfer processing unit 25. Also, in the receiver-side transfer device 2, data to be transferred from the transmitter-side transfer device 1 to the reception terminal 4 passes through the functional configurations in the order of the transfer processing unit 25, the deduplication processing unit 24, and the relay processing unit 21.

The relay processing unit 21 is an interface to the reception terminal 4. The transfer processing unit 25 is an interface to the transmitter-side transfer device 1. The relay processing unit 21 and the transfer processing unit 25 perform the same processes as the relay processing unit 11 and the transfer processing unit 15 of the transmitter-side transfer device 1.

The deduplication processing unit 24 performs the following process on data which is input from the transfer processing unit 25. In the case where data which is input from the transfer processing unit 25 is partial data, the deduplication processing unit 24 stores the partial data in the cache 26. In the case where data which is input from the transfer processing unit 25 is ID data, partial data corresponding to the ID data is read from the cache 26, and the partial data is restored. Additionally, whether data which is input from the transfer processing unit 25 is partial data or ID data can be determined based on the size of the input data, for example.

With respect to data which is received through the file transfer session between the reception terminal 4 and the transmission terminal 3, the deduplication processing unit 24 outputs the data to the relay processing unit 21. On the other hand, data which is received through the look-ahead session C2 is not transferred by the deduplication processing unit 24 to another device. This is because the session is terminated at the receiver-side transfer device 2. In the first embodiment, data which is received by the receiver-side transfer device 2 through the look-ahead session C2 is data of a file which is acquired by the transmitter-side transfer device 1 from the transmission terminal 3 in response to a pseudo file acquisition request.

The cache 26 is the same as the cache 16 of the transmitter-side transfer device 1. In the first embodiment, the transmitter-side transfer device 1 and the receiver-side transfer device 2 are clearly distinguished from each other, but in reality, the transmitter-side transfer device 1 may perform the same process as the receiver-side transfer device 2, or vice versa. Accordingly, in reality, by executing the deduplication program, one transfer device is to achieve the functional configurations of both the transmitter-side transfer device 1 and the receiver-side transfer device 2.

### Flow of Processing

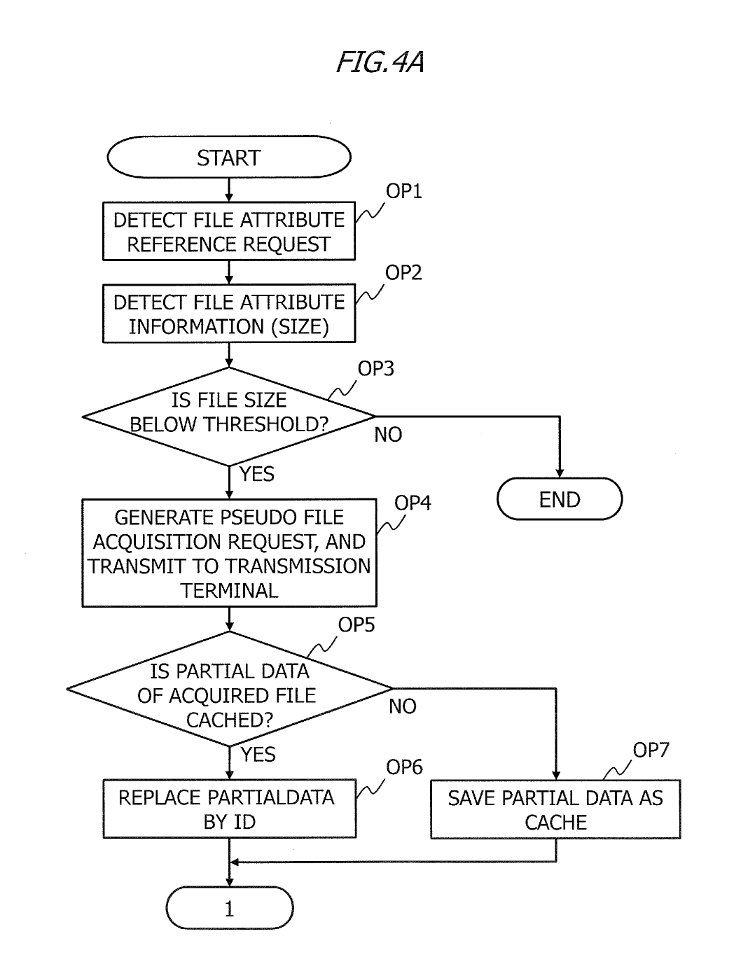

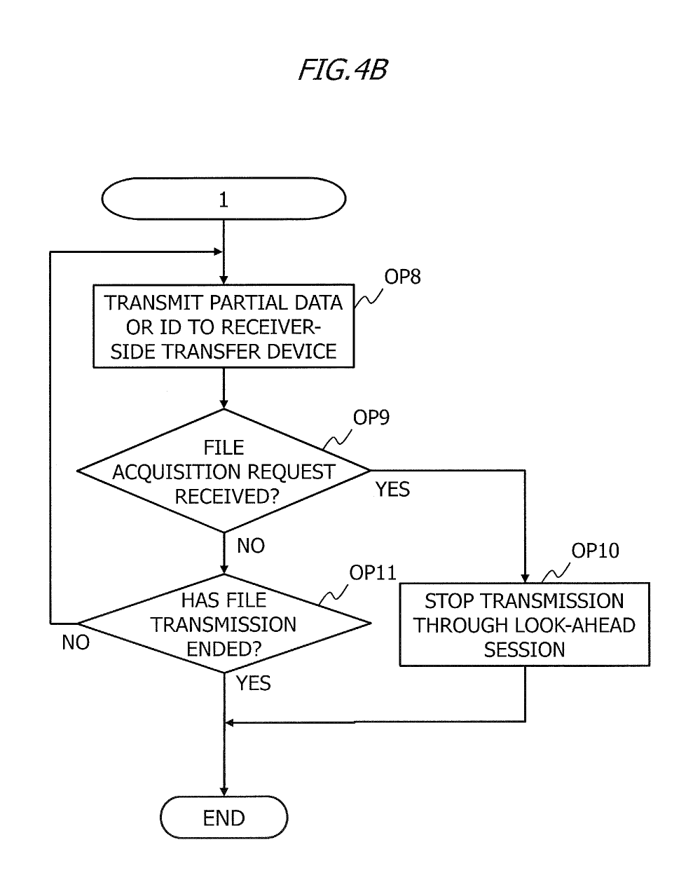

FIGS. 4A and 4B are examples of a flowchart of a process by the transmitter-side transfer device 1. The processes illustrated in FIGS. 4A and 4B are started when the transmitter-side transfer device 1 is activated, and are repeatedly performed during operation of the transmitter-side transfer device 1. The actor of the processes illustrated in FIGS. 4A and 4B is actually the CPU 101, but in the following, the actor is described to be a functional configuration for the sake of convenience.

In OP1, the request determination unit 12 detects a file attribute reference request in data transfer from the receiver-side transfer device 2 to the transmission terminal 3. The process then proceeds to OP2.

In OP2, the request determination unit 12 detects, in data transfer from the transmission terminal 3 to the receiver-side transfer device 2, file attribute information corresponding to the file attribute reference request detected in OP1, and acquires the size of a target file. The process then proceeds to OP3.

In OP3, the request determination unit 12 determines whether the size of the target file is below a threshold. In the case where the size of the target file is below the threshold (OP3: YES), the process proceeds to OP4. In the case where the size of the target file is at or above the threshold (OP3: NO), the request determination unit 12 does not acquire the target file from the transmission terminal 3, and thus, the process illustrated in FIG. 4A is ended.

In OP4, the request determination unit 12 instructs the pseudo-request generation unit 13 to generate a pseudo file acquisition request, and the pseudo-request generation unit 13 generates the pseudo file acquisition request for the target file and transmits the same to the transmission terminal 3. In the case where the look-ahead session C2 is not established, the pseudo-request generation unit 13 establishes the look-ahead session C2, and transmits the pseudo file acquisition request to the transmission terminal 3 by using the look-ahead session C2. Then, data of the target file is transmitted from the transmission terminal 3 in response to the pseudo file acquisition request, and the transmitter-side transfer device 1 receives the data of the target file through the look-ahead session C2. The process then proceeds to OP5.

In OP5, the deduplication processing unit 14 determines whether partial data of the received target file is saved in the cache 16. In the case where the partial data is saved in the cache 16 (OP5: YES), the process proceeds to OP6. In the case where the partial data is not saved in the cache 16 (OP5: NO), the process proceeds to OP7.

In OP6, because the partial data of the target file is saved in the cache 16, the deduplication processing unit 14 replaces the partial data in a data flow which flows through the look-ahead session C2 by ID data. The process then proceeds to OP8.

In OP7, because the partial data of the target file is not saved in the cache 16, the deduplication processing unit 14 stores the partial data in the cache 16. The process then proceeds to OP8.

In OP8, the deduplication processing unit 14 transmits, to the receiver-side transfer device 2, the partial data or the ID data which has replaced the partial data. The process then proceeds to OP9.

In OP9, the request determination unit 12 determines whether a file acquisition request from the reception terminal 4 flowing through the file transfer session C1 is detected during transmission of the target file to the receiver-side transfer device 2 through the look-ahead session C2. In the case where a file acquisition request from the reception terminal 4 flowing through the file transfer session C1 is detected (OP9: YES), the process proceeds to OP10.

In OP10, the request determination unit 12 stops transmission of the target file through the look-ahead session C2, and the processes illustrated in FIGS. 4A and 4B are ended. Additionally, the look-ahead session C2 may be disconnected at the time of stop of transmission of the target file, or may be maintained for a predetermined period of time.

In OP9, in the case where a file acquisition request from the reception terminal 4 flowing through the file transfer session C1 is not detected (OP9: NO), the process proceeds to OP11.

In OP11, the request determination unit 12 determines whether transmission of the target file through the look-ahead session C2 has ended. End of transmission of the target file is detected based on the elapsed period of time when the look-ahead session C2 was not used, for example. In the case where the transmission of the target file through the look-ahead session C2 has ended (OP11: YES), the processes illustrated in FIGS. 4A and 4B are ended. In the case where transmission of the target file has not ended (OP11: NO), the process returns to OP8, and transmission of partial data of the data or ID data to the receiver-side transfer device 2 is continued.

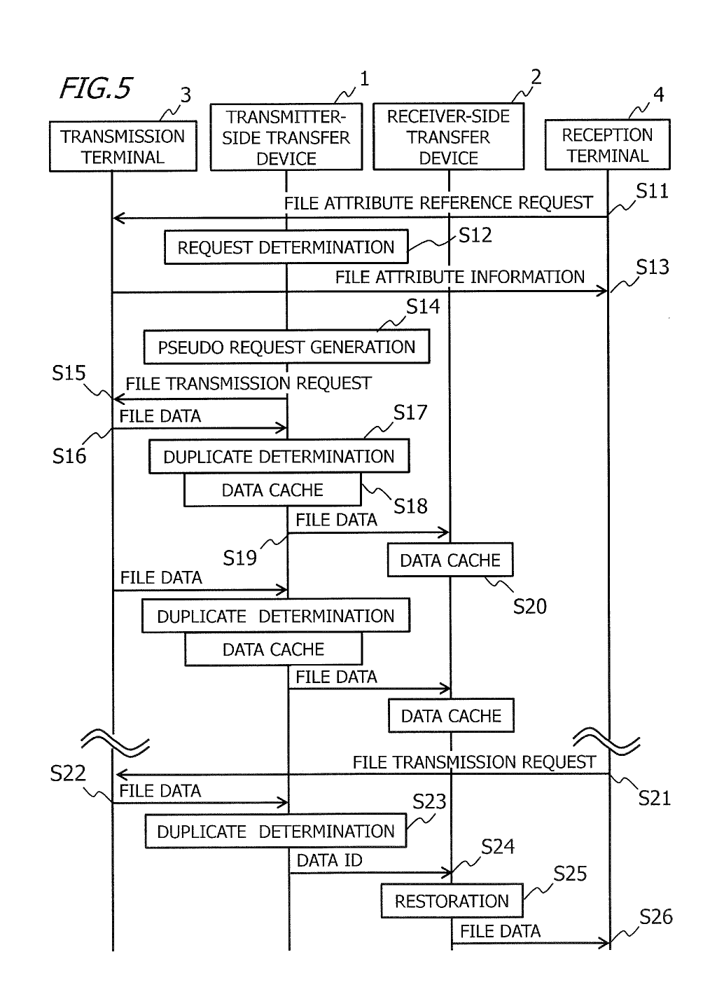

FIG. 5 is a diagram illustrating an example of a sequence of a process by the communication system 100 for a case where a file attribute reference request is transmitted from the reception terminal 4. Additionally, in FIG. 5, the target file is a file having a smaller size than a threshold for the size of a file held by the transmitter-side transfer device 1. Also, in the example illustrated in FIG. 5, data of the target file of the file attribute reference request is assumed to be saved in the caches of neither the transmitter-side transfer device 1 nor the receiver-side transfer device 2.

In S11, the reception terminal 4 transmits a file attribute reference request to the transmission terminal 3 in response to input of a selection operation by a user. The file attribute reference request arrives at the transmission terminal 3 after being transferred by the receiver-side transfer device 2 and the transmitter-side transfer device 1.

In S12, at the time of transferring the file attribute reference request transmitted in S11 by the reception terminal 4, the transmitter-side transfer device 1 detects the file attribute reference request (FIG. 4A, OP1).

In S13, the transmission terminal 3 receives the file attribute reference request from the reception terminal 4, and in response to the file attribute reference request, transmits file attribute information of the target file to the reception terminal 4. The file attribute information arrives at the reception terminal 4 after being transferred by the transmission-side transfer device 1 and the receiver-side transfer device 2.

In S14, the transmitter-side transfer device 1 detects the file attribution information transmitted in S13 by the transmission terminal 3 (FIG. 4A, OP2), and generates a pseudo file acquisition request for the target file (FIG. 4A, OP4). In S15, the transmitter-side transfer device 1 transmits the pseudo file acquisition request to the transmission terminal 3.

In S16, the transmission terminal 3 receives the pseudo file acquisition request from the transmitter-side transfer device 1, and transmits the target file in response to the pseudo file acquisition request. Additionally, the pseudo file acquisition request is perceived by the transmission terminal 3 as a valid file acquisition request according to a corresponding protocol.

In S17, the transmitter-side transfer device 1 receives data of the target file from the transmission terminal 3, and performs the deduplication process (FIG. 4A, OP5). In the example illustrated in FIG. 5, because data of the target file is not saved in the cache 16, the transmitter-side transfer device 1 stores the partial data of the target file in the cache 16 in S18 (FIG. 4A, OP7).

In S19, the transmitter-side transfer device 1 transmits the partial data of the target file to the receiver-side transfer device 2 (FIG. 4B, OP8). In S20, the receiver-side transfer device 2 receives the partial data, and because the partial data is not saved in the cache 26, the receiver-side transfer device 2 stores the partial data in the cache 26.

Then, the process from S16 to S20 is repeated until transmission of the target file is ended. In FIG. 5, transmission of the target file from the transmitter-side transfer device 1 to the receiver-side transfer device 2 is assumed to be ended without occurrence of a file acquisition request for the target file from the reception terminal 4.

In S21, the reception terminal 4 transmits a file acquisition request for the target file to the transmission terminal 3. In S22, the transmission terminal 3 receives the file acquisition request from the reception terminal 4, and transmits data of the target file.

In S23, data of the target file transmitted by the transmission terminal 3 arrives at the transmitter-side transfer device 1, and the transmitter-side transfer device 1 performs the deduplication process on the data. Specifically, the transmitter-side transfer device 1 divides the data into pieces of partial data, and if partial data is saved in the cache 16, the transmitter-side transfer device 1 transmits the ID data of the partial data, and if partial data is not saved in the cache 16, the transmitter-side transfer device 1 transmits the partial data itself.

In S24, because the partial data of the target file is saved in the cache 16 of the transmitter-side transfer device 1, the transmitter-side transfer device 1 transmits the ID data of each piece of partial data.

In S25, the receiver-side transfer device 2 receives the ID data of partial data, reads the partial data corresponding to the ID data from the cache 26, and restores the data. In S26, the receiver-side transfer device 2 transmits the data of the target file to the reception terminal 4.

### Effects of First Embodiment

In the first embodiment, the transmitter-side transfer device 1 acquires a target file from the transmission terminal 3 with transfer of a file attribute reference request from the reception terminal 4 as a trigger, and transmits the target file to the receiver-side transfer device 2. This allows the target file to be saved in the caches of the transmitter-side transfer device 1 and the receiver-side transfer device 2 prior to transmission of a file acquisition request for the target file from the reception terminal 4. Also, even if a file acquisition request for a target file is transmitted from the reception terminal 4 in a state where there is no record of transfer of the target file to the reception terminal 4, the transmitter-side transfer device 1 may transmit the ID data instead of partial data, and the amount of data transfer may be reduced.

Also, a file that is acquired by the transmitter-side transfer device 1 from the transmission terminal 3 is limited to the target file of the file attribute reference request, and thus, the amount of data transfer from the transmitter-side transfer device 1 to the receiver-side transfer device 2 may be suppressed to a small amount.

Furthermore, a data stream of a small size, that is, partial data, is saved in the caches of the transmitter-side transfer device 1 and the receiver-side transfer device 2 instead of a file. For example, after being saved in the caches of the transmitter-side transfer device 1 and the receiver-side transfer device 2, a target file sometimes becomes a file that is different from the target file which is saved in the caches due to a change such as a change in the file name or the like. Also in such a case, if there is a file acquisition request from the reception terminal 4 for the target file after change, partial data which is transferred from the transmitter-side transfer device 1 is limited to the partial data corresponding to the part of the file name with a change. The ID data is transmitted for partial data other than the partial data corresponding to the part of the file name with a change. Accordingly, even if a file which is to be actually transmitted includes a change from the file which is saved in the caches of the transmitter-side transfer device 1 and the receiver-side transfer device 2, the amount of data to be transferred between the transmitter-side transfer device 1 and the receiver-side transfer device 2 may be suppressed to a small amount by the deduplication process.

Furthermore, when a file acquisition request from the reception terminal 4 flowing through the file transfer session is detected during transmission of a target file through the look-ahead session C2, the transmitter-side transfer device 1 stops transfer, through the look-ahead session C2, of the target file to the receiver-side transfer device 2 (FIG. 4B, OP9, OP10). Accordingly, an influence of communication through the look-ahead session C2 on communication through the file transfer session C1 may be suppressed. Moreover, also in this case, the deduplication process is performed on partial data which was stored in the caches of the transmitter-side transfer device 1 and the receiver-side transfer device 2 before occurrence of a file acquisition request from the reception terminal 4, and thus, the amount of data transfer may be reduced compared to a case of transferring the entire file.

Moreover, in the first embodiment, the look-ahead session C2 between the transmitter-side transfer device 1 and the receiver-side transfer device 2 is established separately from the file transfer session C1 between the transmission terminal 3 and the reception terminal 4. For example, the process of transferring a file acquisition request from the reception terminal 4 to the transmitter-side transfer device 1 through the file transfer session C1 may be prevented from being interrupted at the receiver-side transfer device 2 by the process of receiving a target file from the transmitter-side transfer device 1 through the look-ahead session C2. That is, a negative influence on a CIFS session between the transmission terminal 3 and the reception terminal 4 exerted by file transfer between the transmitter-side transfer device 1 and the receiver-side transfer device 2 preceding transmission of a file acquisition request from the reception terminal 4 may be suppressed.

Moreover, in the first embodiment, the transmitter-side transfer device 1 transmits just files of a size below a predetermined threshold to the receiver-side transfer device 2 (FIG. 4A, OP3). This is because transmission of a file of a large size possibly exerts a negative influence on a CIFS session between the transmission terminal 3 and the reception terminal 4 due to transmission of the file taking a long time or compressing the bandwidth, for example. That is, by the transmitter-side transfer device 1 transmitting just files of a size below a predetermined threshold to the receiver-side transfer device 2, a negative influence on a CIFS session between the transmission terminal 3 and the reception terminal 4 may be suppressed.

Moreover, in the first embodiment, the transmitter-side transfer device 1 actively acquires a file by transmitting a file acquisition request to the transmission terminal 3. Accordingly, the transmitter-side transfer device 1 may acquire the latest file at the time point of occurrence of a file attribute reference request, and may save the file in the cache. By acquiring a latest file, the possibility that a target file is changed before a file acquisition request is transmitted by the reception terminal 4 is reduced, and the deduplication process may be performed on a greater number of pieces of partial data, thereby allowing the amount of data transfer to be further reduced.

According to the communication device, the information processing method, and the information processing program of the disclosure, it is possible to reduce the amount of data transfer with respect to transfer of data with no record of transfer to a terminal.

### Others

In the first embodiment, the transmitter-side transfer device 1 and the transmission terminal 3, and the receiver-side transfer device 2 and the reception terminal 4 are described to be separate individual devices. However, the transmitter-side transfer device 1 and the transmission terminal 3 may be achieved by one device. Also, the receiver-side transfer device 2 and the reception terminal 4 may be achieved by one device. Moreover, the transmitter-side transfer device 1 and the receiver-side transfer device 2 may be achieved by one device.

Furthermore, in the first embodiment, transfer of a file attribute reference request from the reception terminal 4 is taken as the trigger, by the transmitter-side transfer device 1, for acquisition of a target file from the transmission terminal 3 (FIG. 4A, OP2), saving of the target file in the cache (FIG. 4A, OP7), and transmission of the target file to the receiver-side transfer device 2 (FIG. 4B, OP8). The trigger for these processes by the transmitter-side transfer device 1 is not limited to transfer of the file attribute reference request from the reception terminal 4. For example, the processes mentioned above may be performed on a file which is highly likely to be the target of a file acquisition request, with establishment of a CIFS session between the transmission terminal 3 and the reception terminal 4 as the trigger.

A file which is highly likely to be the target of a file acquisition request may be determined based on a priority by assigning priorities to files in advance, for example. A priority to be assigned to a file is set based on the number of times of being a target file of a file acquisition request, presence/absence of a keyword such as “important” in the file name, recency of update, or the type of the file, for example.

Furthermore, in OP3 in FIG. 4A of the first embodiment, whether a file size is below a threshold or not is determined, and a file of a size below the threshold is transmitted to the receiver-side transfer device 2. The determination standard for deciding which file is to be transmitted to the receiver-side transfer device 2 is not limited to the file size. For example, the likelihood of being the target of a file acquisition request may be taken as the determination standard.

### Recording Medium

A program for causing a computer or another machine or apparatus (hereinafter, “computer or the like”) to provide any of the above-described functions can be recorded into a recording medium that can be read by a computer or the like. The program in the recording medium is read into the computer or the like and executed, enabling provision of the function.

Here, the recording medium that can be read by the computer or the like refers to a non-temporary recording medium that can store information such as data and/or programs by means of electrical, magnetic, optical, mechanical or chemical action and can be read from the computer or the like. From among such recording mediums, ones that can be removed from the computer or the like include, for example, a flexible disk, a magneto-optical disk, a CD-ROM, a CD-R/W, DVD, a Blu-ray disk, a DAT, an 8 mm tape and a memory card such as a flash memory. Also, recording mediums fixed to the computer or the like include, e.g., a hard disk and a ROM (read-only memory). Furthermore, a SSD (solid state drive) can be used as either a recording medium that can be removed from the computer or the like or a recording medium fixed to the computer or the like.

All examples and conditional language provided herein are intended for the pedagogical purposes of aiding the reader in understanding the invention and the concepts contributed by the inventor to further the art, and are to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A communication device that performs data transfer of a data group from a first device holding the data group to a second device that stores received data as a record of transfer, the communication device comprising:
a storage configured to store transmitted data as a record of transfer; and
a processor configured to:
acquire, from the first device, data matching a predetermined condition among the data group,
store, in the storage, first data that is not retained in the storage among the acquired data, and transmit the first data to the second device, and
transmit identification information of the first data having a smaller size than the first data to the second device, when transfer of the first data from the first device to the second device is started in response to an acquisition request for the first data.

2. The communication device according to claim 1, wherein the processor is configured to:
divide the first data into pieces of partial data of a predetermined size,
transmit to the second device a piece of partial data that is not retained in the storage among the pieces of partial data created by division, and
store in the storage, the piece of partial data that is not retained in the storage among the pieces of partial data created by the division.

3. The communication device according to claim 1, wherein the processor is configured to use a first session for the transmission of the first data matching the predetermined condition among the data group to the second device, and use a second session for transfer of the first data from the first device to the second device performed in response to the acquisition request, the second session is different from the first session.

4. The communication device according to claim 3, wherein the processor is configured to stop transmission that uses the first session, when an acquisition request for the first data is received through the second session during transmission of the first data to the second device through the first session.

5. The communication device according to claim 1, wherein the processor is configured to take, as the first data, data that is not retained in the storage and that has a priority that is higher than a predetermined threshold, among data matching the predetermined condition among the data group.

6. The communication device according to claim 1, wherein the processor is configured to take, as the first data, data of a size below a predetermined threshold, among data matching the predetermined condition among the data group.

7. The communication device according to claim 1, wherein the predetermined condition is that data is a target of a reference request regarding attribute information of data transferred to the first device, and the processor is configured to transmit, to the first device, an acquisition request for target data of the reference request.

8. An information processing method that is performed by a processor of a communication device that performs data transfer of a data group from a first device holding the data group to a second device that stores received data as a record of transfer, the method comprising:
storing transmitted data in a storage as a record of transfer;
acquiring, from the first device, data matching a predetermined condition among the data group;
storing, in the storage, first data that is not retained in the storage among the acquired data, and transmitting the first data to the second device; and
transmitting identification information of the first data having a smaller size than the first data to the second device, when transfer of the first data from the first device to the second device is started in response to an acquisition request for the first data.

9. A non-transitory computer-readable recording medium with an information processing program that causes a processor of a communication device that performs data transfer of a data group from a first device holding the data group to a second device that stores received data as a record of transfer to:
store transmitted data in a storage as a record of transfer;
acquire, from the first device, data matching a predetermined condition among the data group;
store, in the storage, first data that is not retained in the storage among the acquired data, and transmit the first data to the second device; and
transmit identification information of the first data having a smaller size than the first data to the second device, when transfer of the first data from the first device to the second device is started in response to an acquisition request for the first data.
